(19) United States
(12) Patent Application Publication
(10) Pub. No.: US 2004/0196979 A1
(43) Pub. Date: Oct. 7, 2004

(54) Encryption/decryption device and method for a wireless local area network

(76) Inventors: Sheng-Yuan Cheng, Jhubei City (TW); Yung-Yu Liu, Cyonglin Township (TW); Hsin-Hsiung Fang, Anding Township (TW)

Correspondence Address: SEYFARTH SHAW, 55 EAST MONROE STREET, SUITE 4200, CHICAGO, IL, 60603-5803, US

(21) Appl. No.: 10/633,753

(22) Filed: Aug. 4, 2003

(30) Foreign Application Priority Data
Apr. 3, 2003 (TW) 092107680

(51) Int. Cl. H04K 1/00

(52) U.S. Cl. 380/270

(57) ABSTRACT

The encryption/decryption device of the present invention comprises a first encryption/decryption table, and electrically connects a host with a second encryption/decryption table. The content of the first and the second encryption/decryption table comprises a station identifier field, an encryption/decryption algorithm identifier field and a key field for encrypting/decrypting the frames transmitted from or to the station. The encryption/decryption device comprises a data receiving unit, a data transmitting unit, a hardware encryption/decryption unit, a first checking unit and a second checking unit. The hardware encryption/decryption unit will encrypt/decrypt a frame if it can do so, or the encryption/decryption of the frame will be performed by the host.

### BACKGROUND OF THE INVENTION

(A) Field of the Invention

The present invention relates to an encryption/decryption device and method for a wireless local area network, and more particularly, to an encryption/decryption device and method for a wireless local area network using hardware to encrypt/decrypt frames.

(B) Description of Related Art

As portable electronic devices such as mobile handsets, PDAs and notebook computers rapidly become popular, the wireless local area network (WLAN) has become a key concept and technology in the computer and communication industry nowadays. Unlike traditional local area network (LAN), the host in the WLAN does not have to be settled on a node according to the architecture of WLAN. Instead, the host can move anywhere at anytime and still has the ability to access data on the network.

It is very easy to intercept data transmitted in wireless medium. Due to the broadcast characteristics of the radio, one can perform the data interception easily by tuning the receiving frequency of the interceptor to the frequency used by the transmitter to transmit data. To solve this problem, IEEE 802.11 protocol formulates a privacy algorithm equivalent to LAN for authorized WLAN users transmitting data to avoid being intercepted. Since an electrical connection is needed to intercept data in LAN, such inconvenience can be regarded as a security measure. Although the WLAN does not have such security measure, IEEE 802.11 protocol uses WEP (Wired Equivalent Privacy Algorithm) to provide an equivalent security.

According to the WEP operation, the original binary data is encrypted by an encryption algorithm to hide the content of the original binary data. The original binary data is referred to as “plaintext” (P), and the encrypted data as “ciphertext” (C). Cryptographic algorithm (cipher) is a mathematic function used for data encryption and decryption. The technique of “key” (k) has been widely applied to most modern ciphers for both encryption and decryption. Ciphertext is achieved by processing the plaintext with the encryption algorithm (E):

Ek(P)=C

Decryption algorithm (D) uses the same key to process the ciphertext to achieve the plaintext:

Dk(C)=Dk(Ek(P))=P

FIG. 1 is a functional block diagram of an electronic device 10 in the WLAN according to the prior art. As shown in FIG. 1, the electronic device 10 comprises a data receiving unit 12, a decryption checking unit 14, a hardware encryption/decryption unit 16, an encryption checking unit 19, and a data transmitting unit 17. The electronic device 10 connects to an application program (AP) 18 for data transmission. The hardware encryption/decryption unit 16 comprises an encryption/decryption table, which records source address (SA), encryption/decryption algorithms and keys for encrypting/decrypting data transmitted from or to the source station. The source address is the station address where a frame is generated and then received by the data receiving unit 12.

FIG. 2 is a flow chart showing the encryption in the WLAN according to the prior art. When receiving an incoming frame from a source station (not shown in the drawings), the data receiving unit 12 transfers the frame to the decryption checking unit 14. The decryption checking unit 14 checks whether or not the frame needs to be decrypted according to the header of the frame. In other words, the decryption checking unit 14 checks whether the frame is ciphertext or plaintext. The frame will be transferred to the application program 18 if the frame is plaintext, or will be transferred to the hardware encryption/decryption unit 16. If the source address recorded in the header of the frame is stored in the encryption/decryption table of the hardware encryption/decryption unit 16, the decryption of the encrypted frame is succeeded by the hardware encryption/decryption unit 16. The hardware encryption/decryption unit 16 will use the decryption algorithm and the key corresponding to the source address to decrypt the frame into plaintext, and forward the plaintext to the application program 18. However, if the source address recorded in the header of the frame is not stored in the encryption/decryption table of the hardware encryption/decryption unit 16, the hardware encryption/decryption unit 16 will not be able to decrypt the frame into plaintext, and the decryption of the encrypted frame is failed.

FIG. 3 is a flow chart showing the decryption in the WLAN according to the prior art. When the application program 18 needs to transmit data to a destination station, the data is added with a header to form a frame that is then forwarded to the encryption checking unit 19, wherein the header includes the destination address and information indicating whether the frame needs to be encrypted before transmission. The encryption checking unit 19 checks whether or not the frame needs to be encrypted according to the header of the frame. The frame will be transferred to data transmitting unit 17 if it can be transmitted as plaintext, or the frame will be transferred to the hardware encryption/decryption unit 16.

If the destination address recorded in the header of the frame is stored in the encryption/decryption table of the hardware encryption/decryption unit 16, the encryption of the frame is performed by the hardware encryption/decryption unit 16. The hardware encryption/decryption unit 16 will use the encryption algorithm and the key corresponding to the destination station to encrypt the frame into ciphertext, and then forward the encrypted frame to the data transmitting unit 17. However, if the destination address recorded in the header of the frame is not stored in the encryption/decryption table of the hardware encryption/decryption unit 16, the hardware encryption/decryption unit 16 will not be able to encrypt the frame into ciphertext, and the encryption of the frame is failed.

In recent years, new encryption/decryption algorithms are continually developed to ensure the security of the data transmission in the WLAN. However, the hardware encryption/decryption unit 16 cannot be updated to include the new decryption algorithms and keys because these algorithm and key are implemented by the hardware. Consequently, such a drawback restricts the application of an electronic device using the electronic device 10. To comply with the newly developed algorithms, the electronic device must update the hardware encryption/decryption unit 16 all the time, which increases the cost for using the electronic device 10. In addition, it is necessary to redesign the hardware circuit of the hardware encryption/decryption unit 16 to include the newly developed algorithms, which also increases the production cost of the hardware encryption/decryption unit 16.

### SUMMARY OF THE INVENTIION

The first objective of the present invention is to provide an encryption/decryption device for a wireless local area network, which uses a hardware encryption/decryption unit to promote the operation speed of the encryption/decryption and uses the operation power of a host to subsume the newly developed encryption/decryption algorithm.

The second objective of the present invention is to provide an encryption/decryption device for a wireless local area network, which uses a hardware encryption/decryption unit to promote the operation speed of the encryption/decryption and uses the operation power of a programmable encryption/decryption unit to subsume the newly developed encryption/decryption algorithm.

The third objective of the present invention is to provide an encryption method for a wireless local area network, which can increase the flexibility for encrypting data and decrease the complexity for designing a hardware encryption unit.

The fourth objective of the present invention is to provide a decryption method for a wireless local area network, which can increase the flexibility for decrypting data and decrease the complexity for designing a hardware decryption unit.

In order to achieve the above-mentioned objective and avoid the problems of the prior art, the present invention provides an encryption/decryption device for a wireless local area network, which electrically connects to a host with a second encryption/decryption table. The content of the second encryption/decryption table comprises a station identifier field, an encryption/decryption algorithm identifier field and a key field for encrypting/decrypting data for the station. The encryption/decryption device comprises a data receiving unit for receiving frames, a decryption checking unit electrically connected to the data receiving unit, a hardware encryption/decryption unit, a first checking unit electrically connected to the hardware encryption/decryption unit and the decryption checking unit, an encryption checking unit electrically connected to the host, a second checking unit electrically connected to the hardware encryption/decryption unit and the encryption checking unit and a data transmitting unit for transmitting frames.

The hardware encryption/decryption unit is an electrical circuit fabricated according to at least one encryption/decryption algorithm, and comprises a first encryption/decryption table. The content of the first encryption/decryption table comprises a station identifier field, an encryption/decryption algorithm identifier field and a key field for encrypting/decrypting frames. The first checking unit chooses to use either the host or the hardware encryption/decryption unit to decrypt an encrypted frame received by the data receiving unit. The second checking unit checks whether the hardware encryption/decryption unit has to encrypt a frame that is to be encrypted, or the frame has been encrypted by the host, and forward this encrypted frame to the data transmitting unit.

According to another embodiment of the present invention, the encryption/decryption device comprises a hardware encryption/decryption unit, a programmable encryption/decryption unit, a data transmitting unit for transmitting frames, a data receiving unit for receiving frames, a decryption checking unit electrically connected to the data receiving unit, a first checking unit electrically connected to the decryption checking unit and the hardware encryption/decryption unit, an encryption checking unit electrically connected to the programmable encryption/decryption unit, a second checking unit electrically connected to the hardware encryption/decryption unit and the encryption checking unit. The first checking unit chooses to use either the programmable encryption/decryption unit or the hardware encryption/decryption unit to decrypt an encrypted frame received by the data receiving unit. The second checking unit checks whether the hardware encryption/decryption unit has to encrypt a frame that is to be encrypted, or the frame has been encrypted by the programmable encryption/decryption unit, and forward this encrypted frame to the data transmitting unit.

According to the present invention, the decryption method for a wireless local area network first checks whether a received frame is a ciphertext or a plaintext. If the received frame is ciphertext, the method checks whether the received encrypted frame can be decrypted by a hardware decryption unit, which is electrical circuit fabricated according to at least one decryption algorithm. The hardware decryption unit will decrypt the received encrypted frame if the hardware decryption unit is able to decrypt the received encrypted frame, or the received encrypted frame will be decrypted by a programmable decryption unit.

According to the present invention, the encryption method for a wireless local area network first checking whether to encrypt a frame before transmission. If the frame needs to be encrypted before be transmitted, then the method checks whether a hardware encryption unit is able to encrypt the frame. The encryption of the frame is performed by the hardware decryption unit if the hardware decryption unit is able to encrypt the frame, or the frame is encrypted by a programmable decryption unit.

The present invention can update the encryption/decryption algorithms and key of the second encryption/decryption table by a program at any time to subsume the newly improved encryption/decryption algorithms. Compared with the prior art, the present invention possesses the following advantages:

1. The application of the encryption/decryption device will not be restricted, but will increase with the improvement of the encryption/decryption technology.

2. Since the newly developed encryption/decryption algorithms can be subsumed without replacing the entire hardware encryption/decryption unit, the cost is dramatically decreased.

3. Since the hardware encryption/decryption unit cooperates with the host and the load of the hardware and the software can be rearranged, the present invention possesses higher flexibility to encrypt/decrypt a frame.

4. The present invention can use the power of the host to increase the object capable of encrypting/decrypting, and is not restricted by the hardware encryption/decryption table.

### BRIEF DESCRIPTION OF THE DRAWINGS

Other objectives and advantages of the present invention will become apparent upon reading the following description and upon reference to the accompanying drawings in which:

FIG. 1 is a function block diagram of an encryption/decryption device for the WLAN according to the prior art;

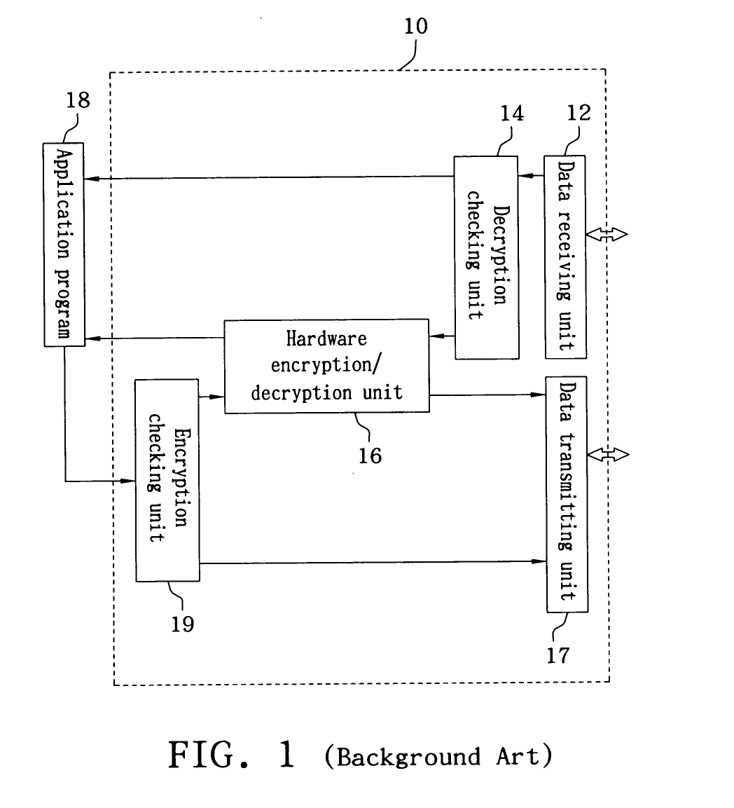

FIG. 2 is a flow chart showing the decryption process of a decryption device according to the prior art;

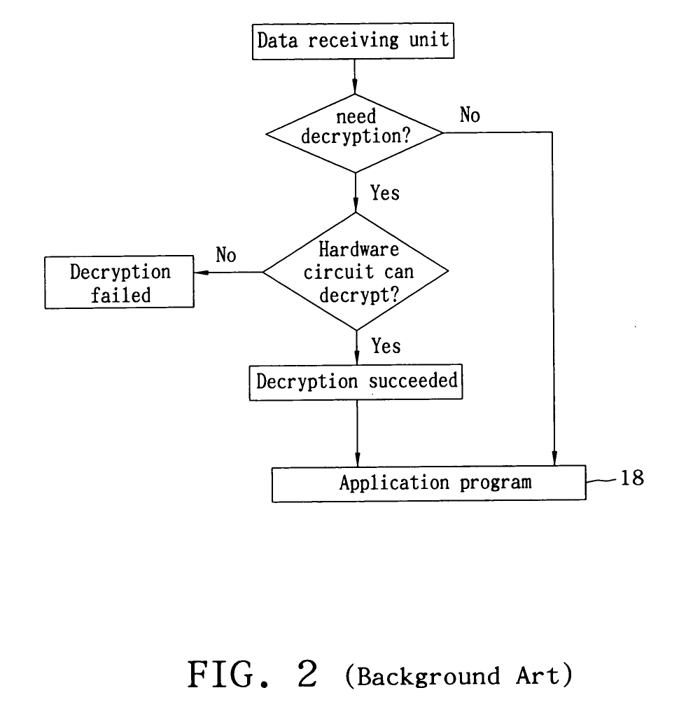

FIG. 3 is a flow chart showing the encryption process of an encryption device according to the prior art;

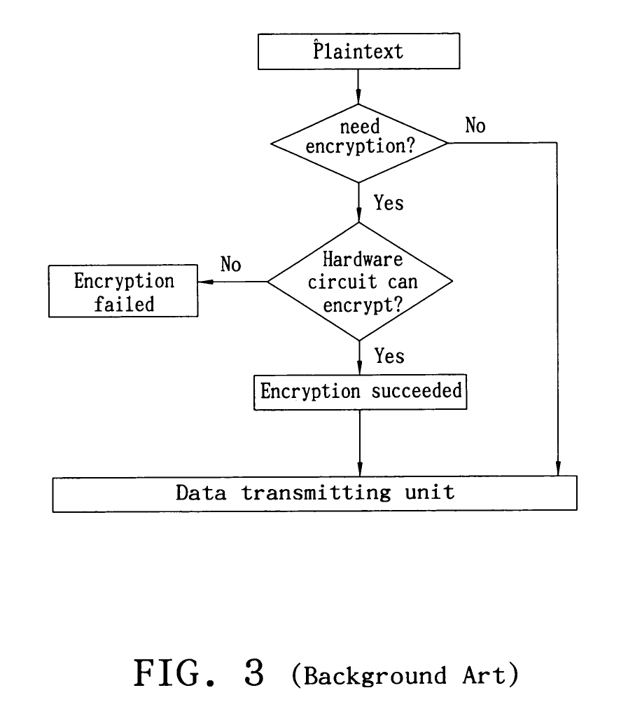

FIG. 4 is a function block diagram of an encryption/decryption device according to the present invention;

FIG. 5 is a function block diagram of an encryption/decryption device according to another embodiment of the present invention;

FIG. 6 is a flow chart showing the decryption process of the decryption method according to the present invention; and

FIG. 7 is a flow chart showing the encryption process of the encryption method according to the present invention.

### DETAILED DESCRIPTION OF THE INVENTION

The present invention will be described in detail with reference of the drawings hereinafter. The station described can be any device with a media access control (MAC) layer interface and the physical (PHY) layer interface of IEEE 802.11 protocol. The station identifier is an identifier for a station, such as the address of the station, and the algorithm identifier is an identifier for an algorithm. The destination station is the final destination of a frame, and the source station is the station that generates the frame. When an element electrically connected to another element is described, it means that the element can be directly connected to the element, or there may be another element between them. Relatively, when an element is directly electrically connected to another element, it means that there is no other element between them.

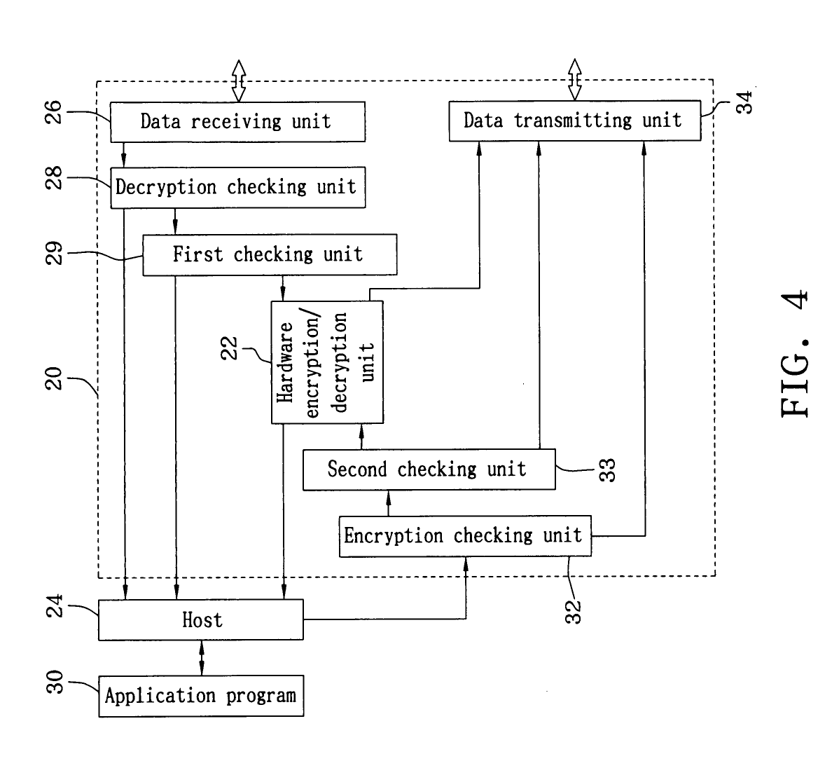

FIG. 4 is a function block diagram of an encryption/decryption device 20 according to the present invention. The encryption/decryption device 20 is electrically connected to a host 24 such as a station or a personal computer. As shown in FIG. 4, the encryption/decryption device 20 comprises a data receiving unit 26 for receiving frames, a decryption checking unit 28 electrically connected to the data receiving unit 26, a hardware encryption/decryption unit 22, a first checking unit 29 electrically connected to the hardware encryption/decryption unit 22 and the decryption checking unit 28, an encryption checking unit 32 electrically connected to the host 24, a second checking unit 33 electrically connected to the hardware encryption/decryption unit 22 and the encryption checking unit 32, and a data transmitting unit 34 for transmitting frames. The first checking unit 29 chooses to use either the host 24 or the hardware encryption/decryption unit 22 to decrypt an encrypted frame received by the data receiving unit 26. The second checking unit 33 checks whether the hardware encryption/decryption unit 22 has to encrypt a frame that is to be encrypted, or the frame has been encrypted by the host 24.

The hardware encryption/decryption unit 22 is an electrical circuit fabricated according to at least one encryption/decryption algorithm, and comprises an embedded first encryption/decryption table, as shown in table 1. The content of the first encryption/decryption table comprises a station identifier field, an encryption/decryption algorithm identifier field and a key field for encrypting/decrypting frames transmitted from or to the station. If the hardware encryption/decryption unit 22 is an electrical circuit fabricated according to only one encryption/decryption algorithm, the content of the first encryption/decryption table can only comprise the station identifier field and the key field.

TABLE 1

| | Encryption/decryption | |
|---|---|---|
| Station identifier | algorithm identifier | Key |
| S A 0 | E/D 0 | K 0 |
| S A 1 | E/D 1 | K 1 |
| S A 2 | E/D 2 | K 2 |
| S A 3 | E/D 3 | K 3 |
| S A 4 | E/D 4 | K 4 |
| . . . | . . . | . . . |

The host 24 comprises a second encryption/decryption table with a format similar to the first encryption/decryption table. The difference between the first and the second encryption/decryption tables is that the second encryption/decryption table is stored in the memory of the host 24. The capacity of the memory of the host 24 is much larger than that of the hardware encryption/decryption unit 22, and therefore the content of the second encryption/decryption table can be updated and added with the newly improved algorithms by a program. Besides, the content of the second encryption/decryption table can be designed to include the entire content of the first encryption/decryption table optionally.

When the data receiving unit 26 receives a frame from a source station, it transfers the frame to the decryption checking unit 28. The decryption checking unit 28 checks whether or not to perform a decryption according to the header of the frame, i.e. it checks whether the frame is ciphertext or plaintext. The frame will be transferred to the first checking unit 29 if it is ciphertext (an encrypted frame), or it will be transferred to the host 24 and processed by the application program 30.

For an encrypted frame, the first checking unit 29 checks whether or not the hardware encryption/decryption unit 22 can decrypt the encrypted frame according to the information recorded in the encrypted frame, such as the address of the source station transmitting the encrypted frame. For example, the first checking unit 29 can check whether or not the source station identifier recorded in the encrypted frame is stored in the first encryption/decryption table. The hardware encryption/decryption unit 22 only can decrypt the encrypted frame into plaintext if source station identifier recorded in the encrypted frame is stored in the first encryption/decryption table, and the first checking unit 29 will transfer the encrypted frame to the hardware encryption/decryption unit 22. From the first encryption/decryption table, the hardware encryption/decryption unit 22 selects a decryption algorithm and a key corresponding to the source station identifier to decrypt the encrypted frame into plaintext.

When the first encryption/decryption table does not store the source station identifier recorded in the encrypted frame, the hardware encryption/decryption unit 22 can not decrypt the encrypted frame into plaintext, and the first checking unit 29 transfers the encrypted frame to the host 24. From the second encryption/decryption table, the host 24 selects a decryption algorithm and a key corresponding to the source station identifier to decrypt the encrypted frame into plaintext and transfer the plaintext to the application program 30.

Similar to the operation of the decryption, when the application program 30 needs to transmit a data to a destination station, the host 24 attaches a header to the data to form a frame wherein the header includes the destination address of the frame and information indicating whether or not to encrypt the frame before transmission. The frame is transferred to the encryption checking unit 32 for checking whether or not to perform an encryption process according to the header of the frame. If the frame is to be transmitted in the plaintext form, it will be transferred to the data transmitting unit 34, or the encryption checking unit 32 will transfer the frame to the second checking unit 33 if the frame needs to be encrypted before be transmitted.

For a frame to be encrypted before transmission, since the second encryption/decryption table of the host 24 includes the entire information of the first encryption/decryption table, including the key and the encryption/decryption algorithm for each station identifier of the hardware encryption/decryption unit 22, the host 24 can check whether or not the destination station identifier of the frame is stored in the first encryption/decryption table. If the destination station identifier is not stored in the first encryption/decryption table of the hardware encryption/decryption unit 22, the frame will be encrypted by the host 24 in advance, and then transferred to the data transmitting unit 34 through the second checking unit 33. From the second encryption/decryption table, the host 24 selects an encryption algorithm and a key corresponding to the destination station identifier to encrypt the frame into ciphertext, which is then transferred to the data transmitting unit 34.

The hardware encryption/decryption unit 22 can only encrypt the frame into ciphertext if the destination station identifier is stored in the first encryption/decryption table. In this case, the host 24 will transfer the frame to the encryption checking unit 32 without encrypting the frame, and the encryption checking unit 32 transfers the frame to the second checking unit 33. The second checking unit 32 checks whether or not the hardware encryption/decryption unit 22 has to encrypt the frame, i.e. it checks if the frame has been encrypted by the host 24. The second checking unit 33 transfers the frame to the hardware encryption/decryption unit 22 if the frame is not yet encrypted by the host 24, or transfers the frame to the data transmitting unit 34 if the frame has been encrypted by the host 24. From the first encryption/decryption table, the hardware encryption/decryption unit 22 selects an encryption algorithm and a key corresponding to the destination station identifier to encrypt the frame into ciphertext, and then transfers the ciphertext to the data transmitting unit 34.

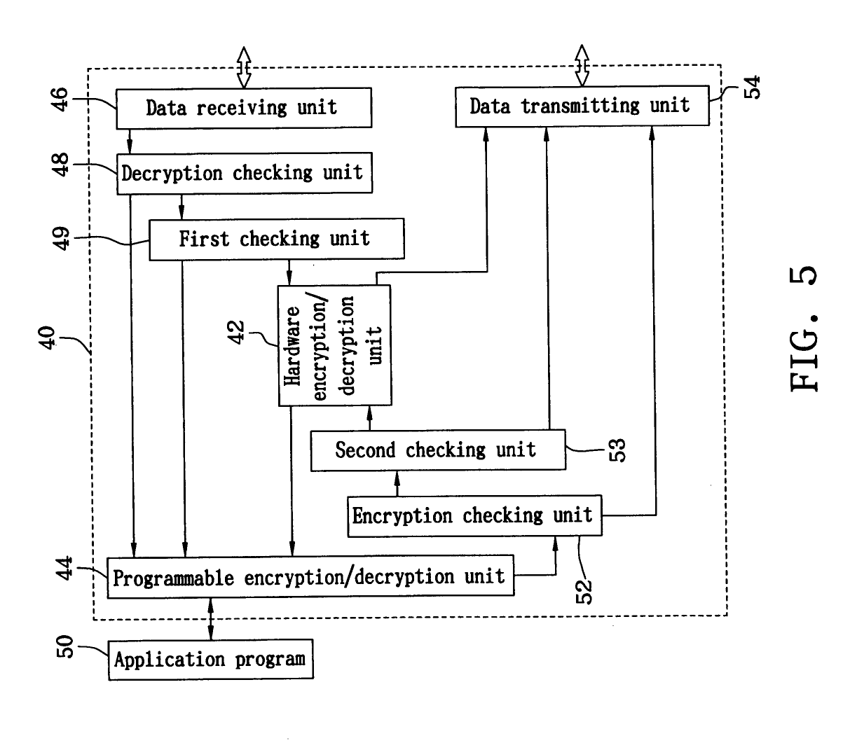

FIG. 5 is a function block diagram of an encryption/decryption device 40 according to another embodiment of the present invention. The encryption/decryption device 40 comprises a hardware encryption/decryption unit 42, a programmable encryption/decryption unit 44, a data transmitting unit 54 for transmitting frames, a data receiving unit 46 for receiving frames, a decryption checking unit 48 electrically connected to the data receiving unit 46, a first checking unit 49 electrically connected to the decryption checking unit 48 and the hardware encryption/decryption unit 42, an encryption checking unit 52 electrically connected to the programmable encryption/decryption unit 44, and a second checking unit 53 electrically connected to the hardware encryption/decryption unit 42 and the encryption checking unit 52. The first checking unit 49 chooses to use either the programmable encryption/decryption unit 44 or the hardware encryption/decryption unit 42 to decrypt an encrypted frame received by the data receiving unit 46. The second checking unit 53 checks whether or not the hardware encryption/decryption unit 42 has to encrypt a frame to be encrypted, or transfer the frame to the data transmitting unit 54.

The hardware encryption/decryption unit 42 is an electrical circuit fabricated according to at least one encryption/decryption algorithms, and comprises a first encryption/decryption table. The content of the first encryption/decryption table comprises a station identifier field, an encryption/decryption algorithm identifier field and a key field for encrypting/decrypting data transmitted from or to the station. If the hardware encryption/decryption unit 42 is electrical circuit fabricated according to only one encryption/decryption algorithm, the content of the first encryption/decryption table can only comprise the station identifier field and the key field.

The programmable encryption/decryption unit 44 is made of a programmable logic element or an embedded system, and comprises a second encryption/decryption table. The content of the second encryption/decryption table comprises a station identifier field, an encryption/decryption algorithm identifier field and a key field for encrypting/decrypting frames transmitted from or to the station. The encryption/decryption algorithm identifiers and keys stored in the second encryption/decryption table can be updated and added with the newly improved algorithms by a program. Besides, the content of the second encryption/decryption table can be designed to include the entire content of the first encryption/decryption table optionally.

When the data receiving unit 46 receives a frame from a source station (not shown in drawings), it transfers the frame to the decryption checking unit 48. The decryption checking unit 48 checks whether or not to perform a decryption process according to the header of the frame. The frame will be transferred to the first checking unit 49 if it is ciphertext (an encrypted frame), or to the application program 50 through the programmable encryption/decryption unit 44 and processed by the application program 50.

For an encrypted frame, the first checking unit 49 checks whether or not the hardware encryption/decryption unit 42 can decrypt the encrypted frame according to the information recorded in the encrypted frame, such as the source station identifier transmitting the encrypted frame. For example, the first checking unit 49 can check whether or not the first encryption/decryption table stores the source station identifier recorded in the encrypted frame. The hardware encryption/decryption unit 42 only can decrypt the encrypted frame into plaintext if the first encryption/decryption table stores the source station identifier, and the first checking unit 49 will transfer the encrypted frame to the hardware encryption/decryption unit 42. From the first encryption/decryption table, the hardware encryption/decryption unit 42 selects a decryption algorithm and a key corresponding to the source station identifier to decrypt the encrypted frame into plaintext, which is then transfered to the application program 50.

When the first encryption/decryption table does not store the source station identifier recorded in the encrypted frame, the hardware encryption/decryption unit 42 can not decrypt the encrypted frame into plaintext, and the first checking unit 49 transfers the encrypted frame to the programmable encryption/decryption unit 44 for performing the decryption. From the second encryption/decryption table, the programmable encryption/decryption unit 44 selects a decryption algorithm and a key corresponding to the source station identifier to decrypt the encrypted frame in to plaintext and transfer the plaintext to the application program 50.

Similar to the operation of the decryption, when the application program 50 needs to transmit a data to a destination station, the programmable encryption/decryption unit 44 attaches a header to the data to form a frame wherein the header includes the destination address of the frame and information indicating whether or not to encrypt the frame before transmission. The frame is then transferred to the encryption checking unit 52 for checking whether or not to perform an encryption process according to the header of the frame. The frame will be transferred to the data transmitting unit 54 if it can be transmitted in the plaintext form, or to the second checking unit 53 if the frame needs to be encrypted before transmission.

For a frame to be transmitted in the ciphertext form, since the second encryption/decryption table of the programmable encryption/decryption unit 44 includes the entire information of the first encryption/decryption table, including the key and the encryption/decryption algorithms for each station identifier of the hardware encryption/decryption unit 42, the programmable encryption/decryption unit 44 can check whether or not the destination station identifier of the frame is stored in the first encryption/decryption table in advance. If the destination station identifier is not stored in the first encryption/decryption table of the hardware encryption/decryption unit 42, the frame will be encrypted by the programmable encryption/decryption unit 44 in advance, and then transferred to the data transmitting unit 54 through the second checking unit 53. From the second encryption/decryption table, the programmable encryption/decryption unit 44 selects the encryption algorithm and the key corresponding to the destination station identifier to encrypt the frame into ciphertext, and then transfers this ciphertext to the data transmitting unit 54.

The hardware encryption/decryption unit 42 only can encrypt the frame into ciphertext if the destination station identifier is stored in the first encryption/decryption table. Under this condition, the programmable encryption/decryption unit 44 will transfer the frame to the encryption checking unit 52 without encrypting it, and the encryption checking unit 52 transfers it to the second checking unit 53. The second checking unit 53 checks whether or not the hardware encryption/decryption unit 52 has to encrypt the frame, i.e. it checks if the frame is already encrypted by the programmable encryption/decryption unit 44. The second checking unit 53 transfers the frame to the hardware encryption/decryption unit 42 if the frame is not yet encrypted by the programmable encryption/decryption unit 44, or to the data transmitting unit 54 if the frame has been encrypted by the programmable encryption/decryption unit 44. From the first encryption/decryption table, the hardware encryption/decryption unit 42 selects an encryption algorithm and a key corresponding to the destination station identifier to encrypt the frame into ciphertext, and then transfers the ciphertext to the data transmitting unit 54.

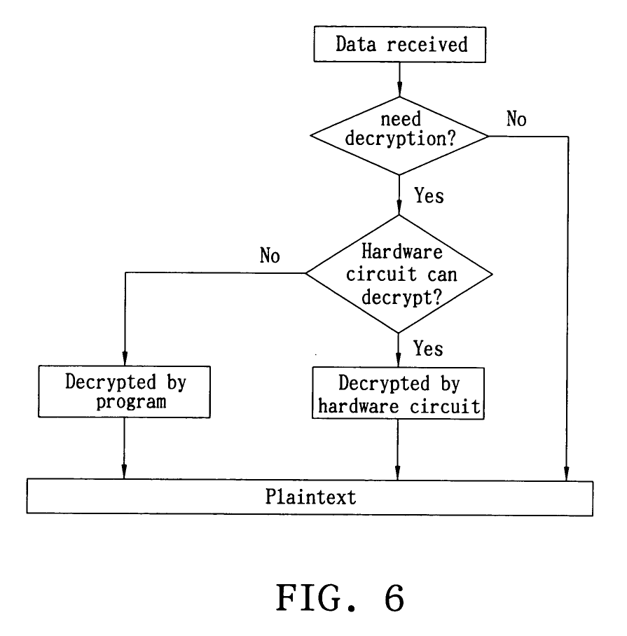

FIG. 6 is a flow chart showing the decryption process of the decryption method according to the present invention. First of all, the present invention method checks whether or not a received frame is a ciphertext or a plaintext, i.e. it checks whether or not the frame needs to be decrypted. If the frame is encrypted as the ciphertext, then checks whether or not a hardware decryption unit can decrypt the encrypted frame into plaintext. The encrypted frame will be transferred to the hardware decryption unit and decrypted into plaintext by the hardware decryption unit if the hardware decryption unit can do the decryption of the frame, or the frame will be decrypted into plaintext by a programmable decryption unit using its internal programs.

The hardware decryption unit is electrical circuit fabricated according to at least one decryption algorithm, and comprises a first decryption table. The programmable decryption unit comprises a second decryption table. The content of the first and the second decryption table comprises a station identifier field, a decryption algorithm identifier field and a key field for decrypting frames transmitted from the station. According to the decryption method of the present invention, to check whether or not the hardware decryption unit can decrypt an encrypted frame into plaintext is to check if the first decryption table stores the source station identifier transmitting the encrypted frame. If the source station identifier is stored in the first decryption table, the hardware decryption unit can decrypt the encrypted frame into plaintext. From the first decryption table, the hardware decryption unit selects a decryption algorithm and a key corresponding to the source station identifier to decrypt the encrypted frame.

The programmable decryption unit can be made of a station, a personal computer, a programmable logic element or an embedded system. The content of the second decryption table can be designed to include the entire content of the first decryption table optionally, including the decryption algorithms and keys. Besides, the decryption algorithms and keys stored in the second decryption table can be updated and added with the newly improved algorithms by a program. From the second decryption table, the programmable decryption unit selects a decryption algorithm and a key corresponding to the source station identifier to decrypt the encrypted frame.

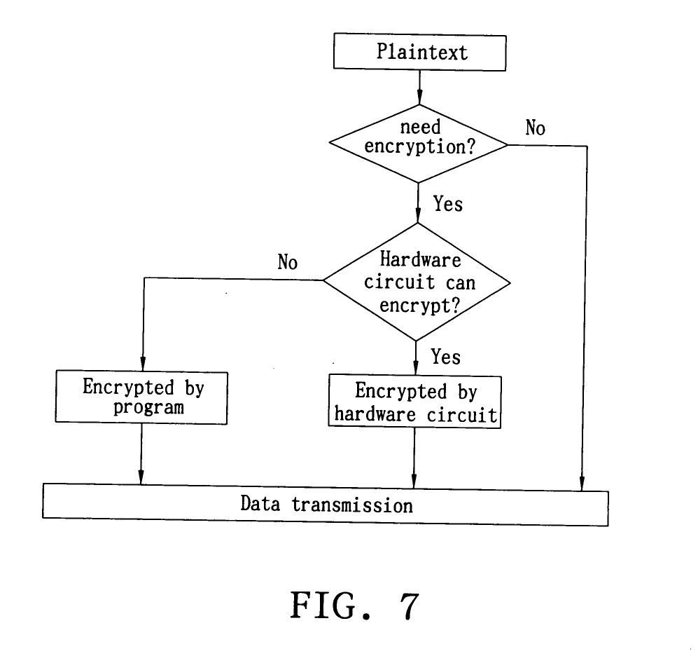

FIG. 7 is a flow chart showing the encryption process of the encryption method according to the present invention. When a data is to be transmitted to a destination station, the present invention first attaches a header to the data to form a frame and checks whether to encrypt the frame before transmission. The frame will be transmitted to the destination station of the frame if it need not be encrypted. If the frame needs to be encrypted before transmission, the present invention checks whether or not a hardware encryption unit can encrypt the frame. The frame will be encrypted by the hardware encryption unit if the hardware encryption unit can encrypt the frame before being transmitted to the destination station of the frame. Otherwise, the frame will be encrypted by a programmable encryption unit using its internal encryption program before being transmitted to the destination of the frame.

The hardware decryption unit is electrical circuit fabricated according to at least one encryption algorithm, and comprises a first encryption table. The programmable encryption unit comprises a second encryption table. The content of the first and the second encryption table comprises a station identifier field, an encryption algorithm identifier field and a key field for encrypting frames to be transmitted to the station. According to the encryption method of the present invention, to check whether the hardware encryption unit can encrypt a frame into ciphertext is to check if the first encryption table stores the destination station identifier. If the destination station identifier is stored in the first encryption table, the hardware encryption unit can encrypt the frame into ciphertext. From the first encryption table, the hardware encryption unit selects an encryption algorithm and a key corresponding to the destination station identifier to encrypt the frame.

The programmable encryption unit can be made of a station, a personal computer, a programmable logic element or an embedded system. The content of the second encryption table can be designed to include the entire content of the first encryption table optionally, including the encryption algorithms and keys. Besides, the encryption algorithms and keys stored in the second encryption table can be updated and added with the newly improved algorithms by a program. From the second encryption table, the programmable encryption unit selects an encryption algorithm and a key corresponding to the destination station identifier to encrypt the frame when the hardware encryption unit can not encrypt the frame.

The present invention can use a program at any time to update the encryption/decryption algorithms and key of the second encryption/decryption table to subsume the newly improved encryption/decryption algorithms. Compared with the prior art, the present invention possesses the following advantages:

1. The application of the encryption/decryption device will not be restricted, but will increase with the improvement of the encryption/decryption technology.

2. Since the newly developed encryption/decryption logarithms can be subsumed without replacing the entire hardware encryption/decryption unit, the cost is dramatically decreased.

3. Since the hardware encryption/decryption unit cooperates with the host and the load of the hardware and the software can be rearranged, the present invention possesses higher flexibility to encrypt/decrypt a frame.

4. The present invention can use the power of the host to increase the object capable of encrypting/decrypting, and is not restricted by the hardware encryption/decryption table.

The above-described embodiments of the present invention are intended to be illustrative only. Numerous alternative embodiments may be devised by those skilled in the art without departing from the scope of the following claims.

What is claimed is:

1. An encryption/decryption device for a wireless local area network, electrically connected to a host with a second encryption/decryption table including a station identifier field, an encryption/decryption algorithm identifier field and a key field for encrypting/decrypting frames, the encryption/decryption device comprising:
a data receiving unit for receiving frames;
a data transmitting unit for transmitting frames;
a hardware encryption/decryption unit with a first encryption/decryption table, wherein the hardware encryption/decryption unit is an electrical circuit fabricated according to at least one encryption/decryption algorithm and the first encryption/decryption table comprises a station identifier field, an encryption/decryption algorithm identifier field and a key field for encrypting/decrypting frames;
a first checking unit electrically connected to the data receiving unit and the hardware encryption/decryption unit, wherein the first checking unit chooses to use either the host or the hardware encryption/decryption unit to decrypt an encrypted frame received by the data receiving unit; and
a second checking unit electrically connected to the hardware encryption/decryption unit and the host, wherein the second checking unit checks whether the hardware encryption/decryption unit has to encrypt a frame that is to be encrypted or the frame has been encrypted by the host.

2. The encryption/decryption device for a wireless local area network of claim 1, wherein the host is a station or a personal computer.

3. The encryption/decryption device for a wireless local area network of claim 1, wherein the second encryption/decryption table can be updated by a program.

4. An encryption/decryption device for a wireless local area network, electrically connected to a host with a second encryption/decryption table, the second encryption/decryption table comprising a station identifier field, an encryption/decryption algorithm identifier field and a key field for encrypting/decrypting frames, the encryption/decryption device comprising:
a data receiving unit for receiving frames;
a data transmitting unit for transmitting frames;
a hardware encryption/decryption unit with a first encryption/decryption table, wherein the hardware encryption/decryption unit is an electrical circuit fabricated according to one encryption/decryption algorithm and the first encryption/decryption table comprises a station identifier field and a key field for encrypting/decrypting frames;
a first checking unit electrically connected to the data receiving unit and the hardware encryption/decryption unit, wherein the first checking unit chooses to use either the host or the hardware encryption/decryption unit to decrypt an encrypted frame received by the data receiving unit; and
a second checking unit electrically connected to the hardware encryption/decryption unit and the host, wherein the second checking unit checks whether the hardware encryption/decryption unit has to encrypt a frame that is to be encrypted or the frame has been encrypted by the host.

5. The encryption/decryption device for a wireless local area network of claim 4, wherein the host is a station or a personal computer.

6. The encryption/decryption device for a wireless local area network of claim 4, wherein the second encryption/decryption table can be updated by a program.

7. An encryption/decryption device for a wireless local area network, comprising:
a data receiving unit for receiving frames;
a data transmitting unit for transmitting frames;
a hardware encryption/decryption unit with a first encryption/decryption table, wherein the hardware encryption/decryption unit is an electrical circuit fabricated according to at least one encryption/decryption algorithm and the first encryption/decryption table comprises a station identifier field, an encryption/decryption algorithm identifier field and a key field for encrypting/decrypting frames;
a programmable encryption/decryption unit with a second encryption/decryption table, wherein the second encryption/decryption table comprises a station identifier field, an encryption/decryption algorithm identifier field and a key field for encrypting/decrypting frames;
a first checking unit electrically connected to the data receiving unit and the hardware encryption/decryption unit, wherein the first checking unit chooses to use either the programmable encryption/decryption unit or the hardware encryption/decryption unit to decrypt an encrypted frame received by the data receiving unit; and
a second checking unit electrically connected to the programmable encryption/decryption unit and the hardware encryption/decryption unit, wherein the second checking unit checks whether the hardware encryption/decryption unit has to encrypt a frame that is to be encrypted or the frame has been encrypted by the programmable encryption/decryption unit.

8. The encryption/decryption device for a wireless local area network of claim 7, wherein the programmable encryption/decryption unit is consisted of a programmable logic element or an embedded system.

9. The encryption/decryption device for a wireless local area network of claim 7, wherein the second encryption/decryption table can be updated by a program.

10. An encryption/decryption device for a wireless local area network, comprising:
a data receiving unit for receiving frames;
a data transmitting unit for transmitting frames;
a hardware encryption/decryption unit with a first encryption/decryption table, wherein the hardware encryption/decryption unit is an electrical circuit fabricated according to one encryption/decryption algorithm and the first encryption/decryption table comprises a station identifier field and a key field for encrypting/decrypting frames;
a programmable encryption/decryption unit with a second encryption/decryption table, wherein the second encryption/decryption table comprises a station identifier field, an encryption/decryption algorithm identifier field and a key field for encrypting/decrypting frames;
a first checking unit electrically connected to the data receiving unit and the hardware encryption/decryption unit, wherein the first checking unit chooses to use either the programmable encryption/decryption unit or the hardware encryption/decryption unit to decrypt an encrypted frame received by the data receiving unit; and
a second checking unit electrically connected to the hardware encryption/decryption unit and the programmable encryption/decryption unit, wherein the second checking unit checks whether the hardware encryption/decryption unit has to encrypt a frame that is to be encrypted or the frame has been encrypted by the programmable encryption/decryption unit.

11. The encryption/decryption device for a wireless local area network of claim 10, wherein the programmable encryption/decryption unit is consisted of a programmable logic element or an embedded system.

12. The encryption/decryption device for a wireless local area network of claim 10, wherein the second encryption/decryption table can be updated by a program.

13. A decryption method for a wireless local area network, comprising the steps of:
checking whether a received frame is a ciphertext or a plaintext;
checking whether a hardware decryption unit can decrypt if the frame is a ciphertext; and
decrypting the frame by the hardware decryption unit if the hardware decryption unit can decrypt the frame, otherwise decrypting the frame by a programmable decryption unit.

14. The decryption method for a wireless local area network of claim 13, wherein the programmable decryption unit is a station, a personal computer, a programmable logic element or an embedded system.

15. The decryption method for a wireless local area network of claim 13, wherein the hardware decryption unit comprises a first decryption table, the programmable decryption unit comprises a second decryption table, and the first and the second decryption tables comprise at least a station identifier field and a key field for decrypting frames.

16. The decryption method for a wireless local area network of claim 13, wherein the second decryption table can be updated by a program.

17. An encryption method for a wireless local area network, comprising the steps of:
checking whether to encrypt a frame before transmission;
checking whether a hardware encryption unit can encrypt the frame if necessary; and
encrypting the frame by the hardware encryption unit if the hardware encryption unit can encrypt the frame, otherwise encrypting the frame by a programmable decryption unit.

18. The encryption method for a wireless local area network of claim 17, wherein the programmable encryption unit is a station, a personal computer, a programmable logic element or an embedded system.

19. The encryption method for a wireless local area network of claim 17, wherein the hardware encryption unit comprises a first encryption table, the programmable encryption unit comprises a second encryption table, and the first and the second encryption tables comprise at least a station identifier field and a key field for encrypting frames.

20. The encryption method for a wireless local area network of claim 17, wherein the second encryption table can be updated by a program.
